(19) United States
(12) Patent Application Publication
(10) Pub. No.: US 2024/0061793 A1
(43) Pub. Date: Feb. 22, 2024

(54) COMPUTING DEVICE AND DATA ACCESS METHOD THEREFOR

(71) Applicant: NEUCHIPS CORPORATION, Hsinchu City (TW)

(72) Inventors: Cheng-Bing Wu, Hsinchu City (TW); YuShan Ruan, New Taipei City (TW)

(73) Assignee: NEUCHIPS CORPORATION, Hsinchu City (TW)

(21) Appl. No.: 17/964,051

(22) Filed: Oct. 12, 2022

(30) Foreign Application Priority Data
Aug. 22, 2022 (TW) 111131565

(51) Int. Cl. G06F 13/16; G06F 13/28

(52) U.S. Cl. CPC G06F 13/1668; G06F 13/28

(57) ABSTRACT

A computing device and a data access method therefor are provided. The computing device includes a bus, a destination memory circuit, and a source memory circuit. The source memory circuit provides multiple pieces of data to the destination memory circuit through the bus based on a burst access instruction. In an embodiment, a source address in the burst access instruction is one of multiple consecutive addresses of a source memory, and a destination address in the burst access instruction is a virtual address. In another embodiment, a source address in the burst access instruction is a virtual address, and a destination address in the burst access instruction is one of multiple consecutive addresses in the destination memory circuit. In yet another embodiment, a source address in the burst access instruction is a first virtual address, and a destination address in the burst access instruction is a second virtual address.

### CROSS-REFERENCE TO RELATED APPLICATION

This application claims the priority benefit of Taiwan application serial no. 111131565, filed on Aug. 22, 2022. The entirety of the above-mentioned patent application is hereby incorporated by reference herein and made a part of this specification.

### BACKGROUND

### Technical Field

The disclosure relates to an electronic device, and more particularly to a computing device and a data access method therefor.

### Description of Related Art

Artificial intelligence (AI) computing requires an efficient and high-speed circuit. The computing circuit of an AI device, such as a matrix engine and a vector engine, are generally equipped with an internal memory to accelerate computations and perform a large number of parallel computations. When the ideal data sequence of the internal memory is inconsistent with the original data sequence, the central processing unit (CPU) or the direct memory access (DMA) controller must handle inconsecutive sequential read and write requirements, thereby increasing the amount of traffic of the bus and reducing resource efficiency.

FIG. 1 and FIG. 2 are schematic diagrams of memory data access of a conventional electronic device. The electronic device shown in FIG. 1 and FIG. 2 includes a bus BUS11, a source memory RAM11, and a destination memory RAM12. A0, A1, A2, A3, A4, A5, A6, A7, . . . shown in FIG. 1 and FIG. 2 represent addresses of the source memory RAM11, and B0, B1, B2, B3, B4, B5, B6, B7, . . . shown in FIG. 1 and FIG. 2 represent addresses of the destination memory RAM12.

The application scenario shown in FIG. 1 is assumed that the source memory RAM11 has four pieces of data with the consecutive addresses A0 to A3 that need to be transmitted to the consecutive addresses B0 to B3 of the destination memory RAM12 through the bus BUS11. Since the source addresses and the destination addresses are both consecutive sequences, the electronic device may transmit the four pieces of data of the source memory RAM11 to the destination memory RAM12 by a burst mode. The pseudo code “Move(A0, B0, 4)” shown in FIG. 1 represents a burst access instruction (data move instruction), where “A0” is a representative address among the consecutive source addresses A0 to A3, “B0” is a representative address among the consecutive destination addresses B0 to B3, and “4” is the data length (burst length) in one burst transmission. Based on burst characteristics, multiple pieces of data with consecutive addresses can be efficiently transmitted.

The application scenario shown in FIG. 2 is assumed that the source memory RAM11 has four pieces of data with the consecutive addresses A0 to A3 that need to be transmitted to the discrete addresses B1, B3, B5, and B7 of the destination memory RAM12 through the bus BUS11. The source addresses are a consecutive sequence, but the destination addresses are a discrete sequence (inconsecutive sequence), so the four pieces of data with the consecutive addresses A0 to A3 cannot be transmitted to the destination memory RAM12 by one burst transmission. Generally speaking, the electronic device transmits the four pieces of data with the consecutive addresses A0 to A3 to the destination memory RAM12 one by one using four data transmission instructions. The four pseudo codes “Move(A0, B1, 1)”, “Move(A1, B3, 1)”, “Move(A2, B5, 1)”, and “Move(A3, B7, 1)” shown in FIG. 2 represent the four data transmission instructions. The pseudo code shown in FIG. 2 may be analogized with reference to the related description of the pseudo code shown in FIG. 1, so there will be no repetition.

Compared with FIG. 1, the scenario shown in FIG. 2 greatly increases bus traffic through the bus BUS11 because the destination addresses are inconsecutive, resulting in a decrease in bus efficiency. The same situation also applies for inconsecutive source addresses. In addition, compared with FIG. 1, the scenario shown in FIG. 2 also causes the CPU or the DMA controller of the electronic device to be occupied. How to improve bus efficiency (that is, reduce the transmission burden of the CPU or the DMA controller) in the scenario of accessing discrete addresses is one of many technical issues in the art.

It should be noted that the content of the “Description of Related Art” section is used to help understand the disclosure. Some content (or all of the content) disclosed in the “Description of Related Art” section may not be known by persons skilled in the art. The content disclosed in the “Description of Related Art” section does not mean that the content has been known to persons skilled in the art before the application of the disclosure.

### SUMMARY

The disclosure provides a computing device and a data access method therefor to improve bus efficiency.

In an embodiment of the disclosure, the computing device includes a bus, a destination memory circuit, and a source memory circuit. The destination memory circuit and the source memory circuit are coupled to the bus. The source memory circuit is used to provide multiple pieces of data to the destination memory circuit through the bus based on a burst access instruction. A source address in the burst access instruction is a representative address among multiple consecutive addresses corresponding to the pieces of data in the source memory circuit, a destination address in the burst access instruction is a virtual address, the destination memory circuit remaps the virtual address to multiple discrete addresses, and the destination memory circuit stores the pieces of data from the bus to the discrete addresses in the destination memory circuit. Alternatively, a source address in the burst access instruction is a virtual address, the source memory circuit remaps the virtual address to multiple discrete addresses, the source memory circuit extracts the pieces of data from the discrete addresses in the source memory circuit to the bus, a destination address in the burst access instruction is a representative address among multiple consecutive addresses in the destination memory circuit, and the destination memory circuit stores the pieces of data from the bus to the consecutive addresses in the destination memory circuit. Alternatively, a source address in the burst access instruction is a first virtual address, the source memory circuit remaps the first virtual address to multiple first discrete addresses, the source memory circuit extracts the pieces of data from the first discrete addresses in the source memory circuit to the bus, a destination address in the burst access instruction is a second virtual address, the destination memory circuit remaps the second virtual address to multiple second discrete addresses, and the destination memory circuit stores the pieces of data from the bus to the second discrete addresses in the destination memory circuit.

In an embodiment of the disclosure, the data access method includes the following steps. Multiple pieces of data are provided to a destination memory circuit of a computing device through a bus of the computing device based on a burst access instruction by a source memory circuit of the computing device. A source address in the burst access instruction is a representative address among multiple consecutive addresses corresponding to the pieces of data in the source memory circuit, and a destination address in the burst access instruction is a virtual address. The virtual address is remapped to multiple discrete addresses by the destination memory circuit. The pieces of data from the bus are stored to the discrete addresses in the destination memory circuit by the destination memory circuit.

In an embodiment of the disclosure, the data access method includes the following steps. A virtual address is remapped to multiple discrete addresses by a source memory circuit of a computing device. Multiple pieces of data are extracted from the discrete addresses in the source memory circuit by the source memory circuit. The pieces of data are provided to a destination memory circuit of the computing device through a bus of the computing device based on a burst access instruction by the source memory circuit. A source address in the burst access instruction is a virtual address, and a destination address in the burst access instruction is a representative address among multiple consecutive addresses in the destination memory circuit. The pieces of data from the bus are stored to the consecutive addresses in the destination memory circuit by the destination memory circuit.

In an embodiment of the disclosure, the data access method includes the following steps. A first virtual address is remapped to multiple first discrete addresses by a source memory circuit of a computing device. Multiple pieces of data are extracted from the first discrete addresses in the source memory circuit by the source memory circuit. The pieces of data are provided to a destination memory circuit of the computing device through a bus of the computing device based on a burst access instruction by the source memory circuit. A source address in the burst access instruction is the first virtual address, and a destination address in the burst access instruction is a second virtual address. The second virtual address is remapped to multiple second discrete addresses by the destination memory circuit. The pieces of data from the bus are stored to the second discrete addresses in the destination memory circuit by the destination memory circuit.

Based on the above, the computing device and the data access method therefor according to the embodiments of the disclosure may be applicable to the situation where the source address and/or the destination address are inconsecutive. In the case where multiple access addresses in the source memory circuit are multiple discrete addresses, the source address in the burst access instruction is the virtual address. The source memory circuit may remap the virtual address to the discrete addresses in the source memory circuit, so as to correctly extract the pieces of data to the bus. For the bus, the source address (virtual address) in the burst access instruction is the representative address among the consecutive source addresses. In the case where multiple access addresses in the destination memory circuit are multiple discrete addresses, the destination address in the burst access instruction is another virtual address. The destination memory circuit may remap the virtual address to the discrete addresses in the destination memory circuit, so as to store the pieces of data from the bus to the correct addresses in the destination memory circuit. For the bus, the destination address (virtual address) in the burst access instruction is the representative address among the consecutive destination addresses. Therefore, regardless of whether the source addresses are inconsecutive and/or the destination addresses are inconsecutive, the bus may operate in a burst mode to reduce bus traffic and improve bus efficiency.

In order for the features and advantages of the disclosure to be more comprehensible, the following specific embodiments are described in detail in conjunction with the drawings.

### BRIEF DESCRIPTION OF THE DRAWINGS

FIG. 1 and FIG. 2 are schematic diagrams of memory data access of a conventional electronic device.

FIG. 3 is a schematic diagram of a circuit block of a computing device according to an embodiment of the disclosure.

FIG. 4 is a schematic flowchart of a data access method of a computing device according to an embodiment of the disclosure.

FIG. 5 is a schematic diagram of memory data access of a computing device according to an embodiment of the disclosure.

FIG. 6 is a schematic flowchart of a data access method of a computing device according to another embodiment of the disclosure.

FIG. 7 is a schematic diagram of memory data access of a computing device according to another embodiment of the disclosure.

FIG. 8 is a schematic flowchart of a data access method of a computing device according to yet another embodiment of the disclosure.

FIG. 9 is a schematic diagram of memory data access of a computing device according to yet another embodiment of the disclosure.

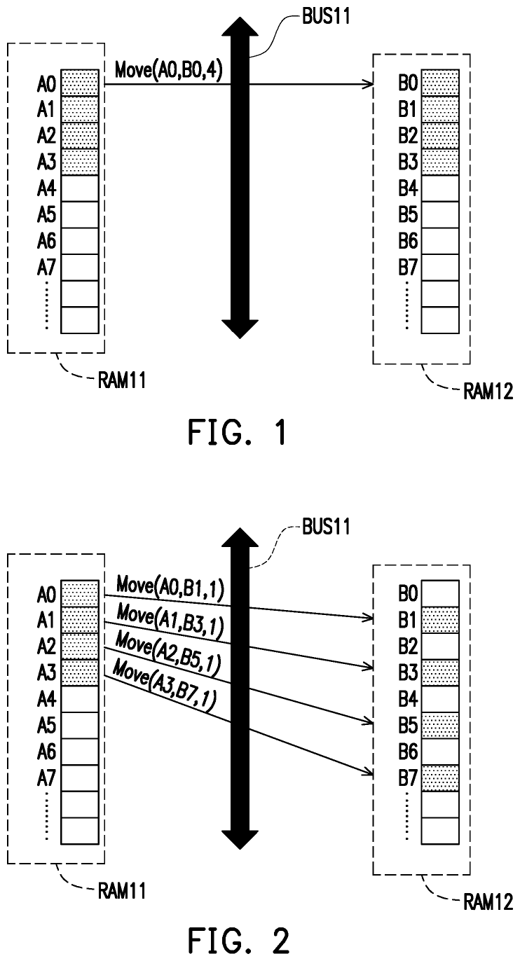

### DETAILED DESCRIPTION OF DISCLOSED EMBODIMENTS

The term “coupling (or connection)” used in the entire specification (including the claims) of the disclosure may refer to any direct or indirect connection means. For example, if a first device is described as being coupled (or connected) to a second device, it should be interpreted that the first device may be directly connected to the second device or the first device may be indirectly connected to the second device through another device or certain connection means. Terms such as “first” and “second” mentioned in the entire specification (including the claims) of the disclosure are used to name the elements or to distinguish between different embodiments or ranges, but not to limit the upper limit or the lower limit of the number of elements or to limit the sequence of the elements. In addition, wherever possible, elements/components/steps using the same reference numerals in the drawings and the embodiments represent the same or similar parts. Related descriptions of the elements/components/steps using the same reference numerals or using the same terminologies in different embodiments may be cross-referenced.

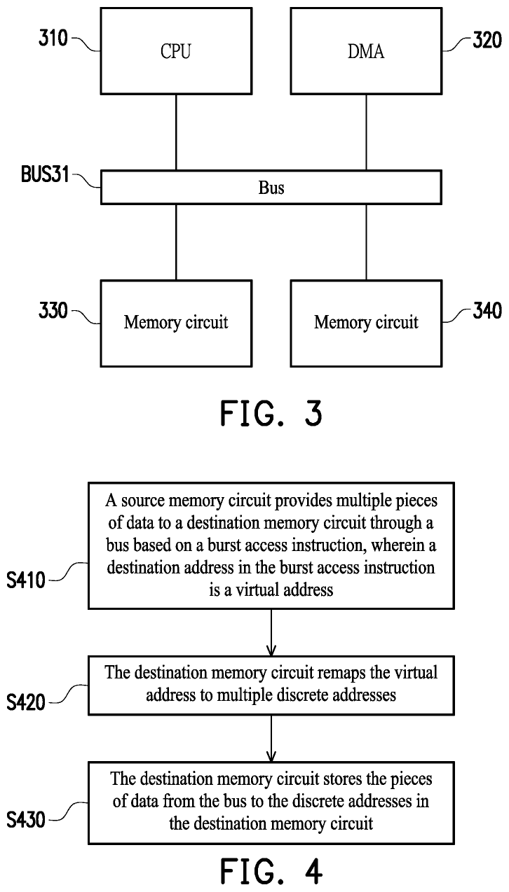

FIG. 3 is a schematic diagram of a circuit block of a computing device according to an embodiment of the disclosure. The computing device shown in FIG. 3 includes a central processing unit (CPU) 310, a direct memory access (DMA) controller 320, a bus BUS31, a memory circuit 330, and a memory circuit 340. The CPU 310, the DMA controller 320, the memory circuit 330, and the memory circuit 340 are all coupled to the bus BUS31.

Based on the current operating scenario, one of the memory circuit 330 and the memory circuit 340 may be a source memory circuit for data transmission, and the other one of the memory circuit 330 and the memory circuit 340 may be a destination memory circuit for data transmission. The DMA controller 320 may issue a burst access instruction to control the source memory circuit to provide multiple pieces of data, and control the destination memory circuit to store the pieces of data.

For example, based on an access instruction (for example, the burst access instruction) of the CPU 310 or the DMA controller 320, the memory circuit 330 (source memory circuit) may provide the pieces of data to the memory circuit 340 (destination memory circuit) through the bus BUS31. Alternatively, the memory circuit 340 (source memory circuit) may provide the pieces of data to the memory circuit 330 (destination memory circuit) through the bus BUS31. When multiple access addresses in the source memory circuit are multiple discrete addresses, a source address in the burst access instruction is a virtual address. When multiple access addresses in the destination memory circuit are multiple discrete addresses, a destination address in the burst access instruction is a virtual address.

According to the actual design, in some embodiments, the memory circuit 330 and the memory circuit 340 may be different main memories. In other embodiments, one of the memory circuits 330 and 340 may be the main memory, and the other one of the memory circuits 330 and 340 may be an internal memory in a computing circuit. Based on practical applications, the computing circuit may be a computing circuit of an AI device, such as a matrix engine and a vector engine.

FIG. 4 is a schematic flowchart of a data access method of a computing device according to an embodiment of the disclosure. Please refer to FIG. 3 and FIG. 4. In Step S410, the source memory circuit (one of the memory circuits 330 and 340) may provide multiple pieces of data to the destination memory circuit (the other one of the memory circuits 330 and 340) through the bus BUS31 based on a burst access instruction. The source address in the burst access instruction is a representative address among multiple consecutive addresses corresponding to the pieces of data in the source memory circuit, and the destination address in the burst access instruction is the virtual address. In Step S420, the destination memory circuit may remap the virtual address to multiple discrete addresses in the destination memory circuit. In Step S430, the destination memory circuit may store the pieces of data from the bus BUS31 to the discrete addresses in the destination memory circuit.

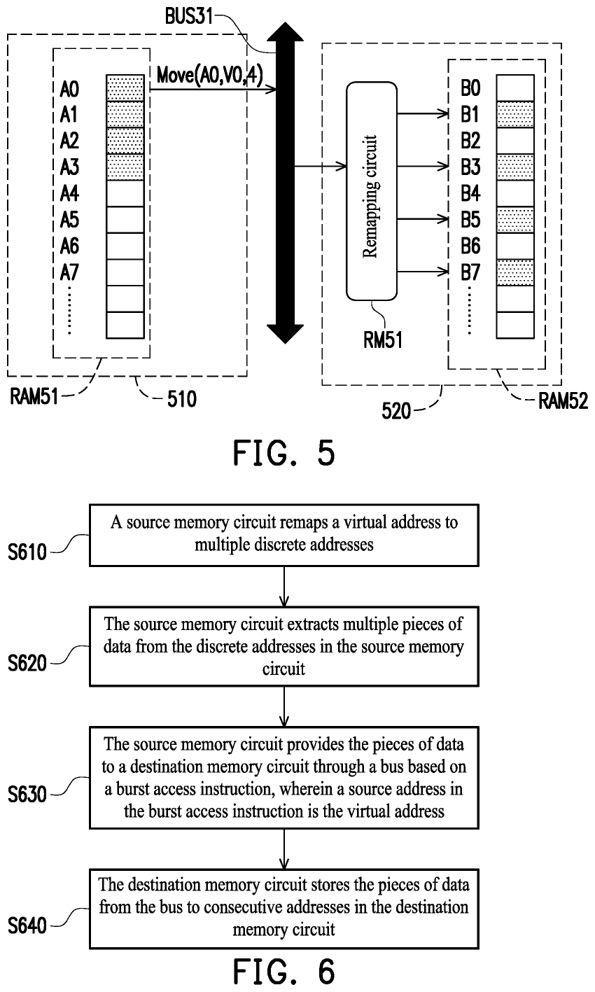

For example, FIG. 5 is a schematic diagram of memory data access of a computing device according to an embodiment of the disclosure. For a bus BUS31 shown in FIG. 5, reference may be made to the related description of the bus BUS31 shown in FIG. 3. A source memory circuit 510 shown in FIG. 5 may be one of the memory circuits 330 and 340 shown in FIG. 3, and a destination memory circuit 520 shown in FIG. 5 may be the other one of the memory circuits 330 and 340 shown in FIG. 3. In the embodiment shown in FIG. 5, the source memory circuit 510 includes a source memory RAM51, and the destination memory circuit 520 includes a remapping circuit RM51 and a destination memory RAM52. The remapping circuit RM51 is coupled to the destination memory RAM52. A0, A1, A2, A3, A4, A5, A6, A7, . . . shown in FIG. 5 represent addresses of the source memory RAM51, and B0, B1, B2, B3, B4, B5, B6, B7, . . . shown in FIG. 5 represent addresses of the destination memory RAM52.

The application scenario shown in FIG. 5 is assumed that the source memory RAM51 has four pieces of data with the consecutive addresses A0 to A3 that need to be transmitted to the discrete addresses B1, B3, B5, and B7 of the destination memory RAM52 through the bus BUS31. The source addresses are a consecutive sequence, but the destination addresses are a discrete sequence (inconsecutive sequence), so the embodiment shown in FIG. 5 uses a virtual address V0 to represent the discrete addresses B1, B3, B5, and B7. The pseudo code “Move(A0, V0, 4)” shown in FIG. 5 represents a burst access instruction (data move instruction), where “A0” is a representative address among the consecutive addresses A0 to A3 of the source memory RAM51, “V0” is the virtual address, and “4” is the data length (burst length) in one burst transmission.

The remapping circuit RM51 may remap the virtual address V0 of the burst access instruction to the discrete addresses B1, B3, B5, and B7 of the destination memory RAM52 (Step S420). The destination memory RAM52 may store the pieces of data from the bus BUS31 to the discrete addresses B1, B3, B5, and B7 of the destination memory RAM52 (Step S430). For the bus BUS31, the virtual address V0 in the burst access instruction “Move(A0, V0, 4)” is a representative address among multiple consecutive destination addresses. Based on this, the bus BUS31 may operate in a burst mode. Based on burst characteristics, the bus BUS31 can efficiently transmit multiple pieces of data with consecutive addresses. Therefore, the bus BUS31 operating in the burst mode can reduce bus traffic and improve bus efficiency.

FIG. 6 is a schematic flowchart of a data access method of a computing device according to another embodiment of the disclosure. Please refer to FIG. 3 and FIG. 6. In Step S610, the source memory circuit (one of the memory circuits 330 and 340) may remap a virtual address to multiple discrete addresses. In Step S620, the source memory circuit may extract multiple pieces of data from the discrete addresses in the source memory circuit to the bus BUS31. In Step S630, the source memory circuit may provide the pieces of data to the destination memory circuit (the other one of the memory circuits 330 and 340) through the bus BUS31 based on a burst access instruction. The source address in the burst access instruction is the virtual address, and the destination address in the burst access instruction is a representative address among multiple consecutive addresses in the destination memory circuit. In Step S640, the destination memory circuit may store the pieces of data from the bus BUS31 to the consecutive addresses in the destination memory circuit.

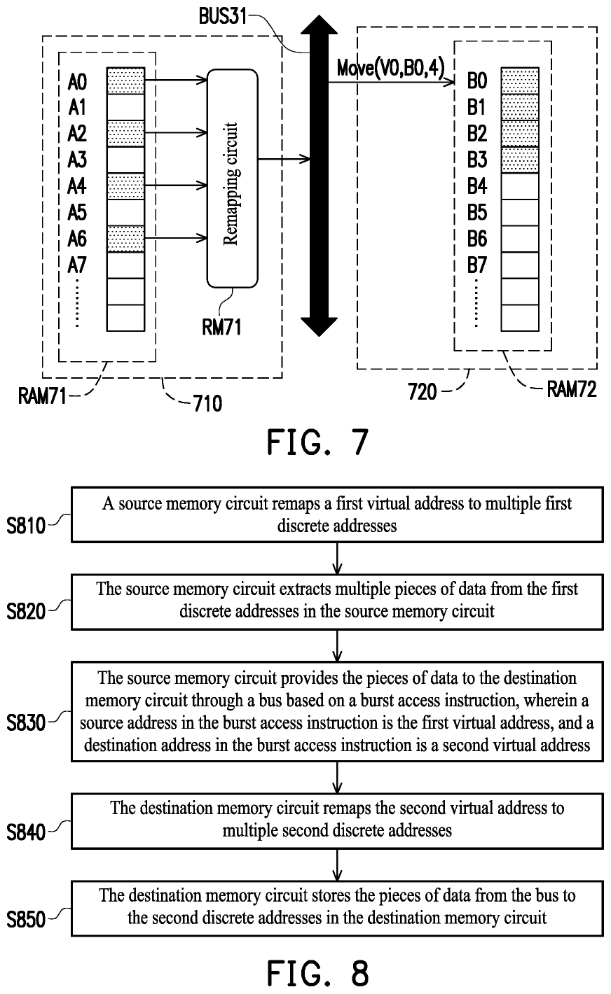

For example, FIG. 7 is a schematic diagram of memory data access of a computing device according to another embodiment of the disclosure. For a bus BUS31 shown in FIG. 7, reference may be made to the related description of the bus BUS31 shown in FIG. 3. A source memory circuit 710 shown in FIG. 7 may be one of the memory circuits 330 and 340 shown in FIG. 3, and a destination memory circuit 720 shown in FIG. 7 may be the other one of the memory circuits 330 and 340 shown in FIG. 3. In the embodiment shown in FIG. 7, the source memory circuit 710 includes a remapping circuit RM71 and a source memory RAM71, and the destination memory circuit 720 includes a destination memory RAM72. The remapping circuit RM71 is coupled to the destination memory RAM72. A0, A1, A2, A3, A4, A5, A6, A7, . . . shown in FIG. 7 represent addresses of the source memory RAM71, and B0, B1, B2, B3, B4, B5, B6, B7, . . . shown in FIG. 7 represent addresses of the destination memory RAM72.

The application scenario shown in FIG. 7 is assumed that the source memory RAM71 has four pieces of data with the discrete addresses A0, A2, A4, and A6 that need to be transmitted to the consecutive addresses B0 to B3 of the destination memory RAM72 through the bus BUS31. The destination addresses are a consecutive sequence, but the source addresses are a discrete sequence (inconsecutive sequence), so the embodiment shown in FIG. 7 uses a virtual address V0 to represent the discrete addresses A0, A2, A4, and A6. The pseudo code “Move(V0, B0, 4)” shown in FIG. 7 represents a burst access instruction (data move instruction), where “V0” is the virtual address, “B0” is a representative address among the consecutive addresses B0 to B3 of the destination memory RAM72, and “4” is the data length (burst length) in one burst transmission.

The remapping circuit RM71 remaps the virtual address V0 to the discrete addresses A0, A2, A4, and A6 of the source memory RAM71 (Step S610). The source memory RAM71 extracts multiple pieces of data from the discrete addresses A0, A2, A4, and A6 of the source memory RAM71 to the bus BUS31 (Step S620). The destination memory RAM72 stores the pieces of data from the bus BUS31 to the consecutive addresses B0 to B3 of the destination memory RAM72 (Step S640). For the bus BUS31, the virtual address V0 in the burst access instruction “Move(V0, B0, 4)” is a representative address among multiple consecutive destination addresses. Based on this, the bus BUS31 may operate in a burst mode. Based on burst characteristics, the bus BUS31 can efficiently transmit multiple pieces of data with consecutive addresses. Therefore, the bus BUS31 operating in the burst mode can reduce bus traffic and improve bus efficiency. FIG. 8 is a schematic flowchart of a data access method of a computing device according to yet another embodiment of the disclosure. Please refer to FIG. 3 and FIG. 8. In Step S810, the source memory circuit (one of the memory circuits 330 and 340) may remap a first virtual address to multiple first discrete addresses. In Step S820, the source memory circuit may extract multiple pieces of data from the first discrete addresses in the source memory circuit to the bus BUS31. In Step S830, the source memory circuit may provide the pieces of data to the destination memory circuit (the other one of the memory circuits 330 and 340) through the bus BUS31 based on a burst access instruction. The source address in the burst access instruction is the first virtual address, and the destination address in the burst access instruction is a second virtual address. In Step S840, the destination memory circuit remaps the second virtual address to multiple second discrete addresses. In Step S850, the destination memory circuit may store the pieces of data from the bus BUS31 to the second discrete addresses in the destination memory circuit.

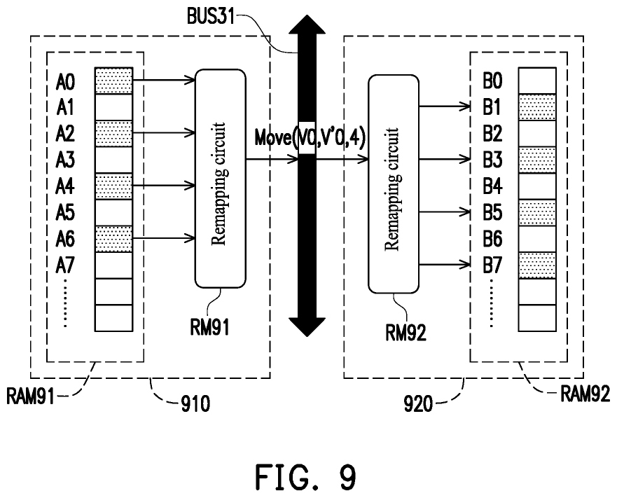

For example, FIG. 9 is a schematic diagram of memory data access of a computing device according to yet another embodiment of the disclosure. For a bus BUS31 shown in FIG. 9, reference may be made to the related description of the bus BUS31 shown in FIG. 3. A source memory circuit 910 shown in FIG. 9 may be one of the memory circuits 330 and 340 shown in FIG. 3, and a destination memory circuit 920 shown in FIG. 9 may be the other one of the memory circuits 330 and 340 shown in FIG. 3. In the embodiment shown in FIG. 9, the source memory circuit 910 includes a remapping circuit RM91 and a source memory RAM91, and the destination memory circuit 920 includes a remapping circuit RM92 and a destination memory RAM92. The remapping circuit RM91 is coupled to the source memory RAM91, and the remapping circuit RM92 is coupled to the destination memory RAM92. A0, A1, A2, A3, A4, A5, A6, A7, . . . shown in FIG. 9 represent addresses of the source memory RAM91, and B0, B1, B2, B3, B4, B5, B6, B7, . . . shown in FIG. 9 represent addresses of the destination memory RAM92.

The application scenario shown in FIG. 9 is assumed that the source memory RAM91 has four pieces of data with the discrete addresses A0, A2, A4, and A6 that need to be transmitted to the discrete addresses B1, B3, B5, and B7 in the destination memory RAM92 through the bus BUS31. The destination addresses and the source addresses are both discrete sequences (inconsecutive sequences), so the embodiment shown in FIG. 9 uses a virtual address V0 (first virtual address) to represent the discrete addresses A0, A2, A4, and A6 (first discrete addresses), and use another virtual address V′0 (second virtual address) to represent the discrete addresses B1, B3, B5, and B7 (second discrete addresses). The pseudo code “Move(V0, V′0, 4)” shown in FIG. 9 represents a burst access instruction (data move instruction), where “V0” is the first virtual address, “V′0” is the second virtual address, and “4” is the data length (burst length) in one burst transmission.

The remapping circuit RM91 remaps the first virtual address V0 to the first discrete addresses A0, A2, A4, and A6 of the source memory RAM91 (Step S810). The source memory RAM91 extracts multiple pieces of data from the first discrete addresses A0, A2, A4, and A6 of the source memory RAM91 to the bus BUS31 (Step S820). The remapping circuit RM92 may remap the second virtual address V′0 of the burst access instruction to the second discrete addresses B1, B3, B5, and B7 of the destination memory RAM92 (Step S840). The destination memory RAM52 may store the pieces of data from the bus BUS31 to the second discrete addresses B1, B3, B5, and B7 of the destination memory RAM52 (Step S850). For the bus BUS31, the virtual address V0 in the burst access instruction “Move(V0, V′0, 4)” is a representative address among multiple consecutive source addresses, and the virtual address V′0 is a representative address among multiple consecutive destination addresses. Based on this, the bus BUS31 may operate in a burst mode. Based on burst characteristics, the bus BUS31 can efficiently transmit multiple pieces of data with consecutive addresses. Therefore, the bus BUS31 operating in the burst mode can reduce bus traffic and improve bus efficiency.

According to different design requirements, in some embodiments, the implementation of the remapping circuits RM51, RM71, RM91, and/or RM92 may be hardware circuits. In other embodiments, the implementation of the remapping circuits RM51, RM71, RM91, and/or RM92 may be firmware, software (that is, programs), or a combined form of the two. In still other embodiments, the implementation of the remapping circuits RM51, RM71, RM91, and/or RM92 may be a combined form of multiple of hardware, firmware, and software.

In terms of the form of hardware, the remapping circuits RM51, RM71, RM91, and/or RM92 may be implemented as logic circuits on integrated circuits. For example, the related functions of the remapping circuits RM51, RM71, RM91, and/or RM92 may be implemented in one or more controllers, microcontrollers, microprocessors, application-specific integrated circuits (ASICs), digital signal processors (DSPs), field programmable gate arrays (FPGAs), and/or various logic blocks, modules, and circuits in other processing units. The related functions of the remapping circuits RM51, RM71, RM91, and/or RM92 may be implemented in hardware circuits, such as various logic blocks, modules, and circuits in integrated circuits, using hardware description languages (for example, Verilog HDL or VHDL) or other suitable programming languages. The remapping circuits RM51, RM71, RM91, and/or RM92 may include a look-up table or a conversion function (computing formula).

In terms of the form of software and/or firmware, the related functions of the remapping circuits RM51, RM71, RM91, and/or RM92 may be implemented by programming codes. For example, the remapping circuits RM51, RM71, RM91, and/or RM92 are implemented using general programming languages (for example, C, C++, or assembly language) or other suitable programming languages. The programming codes may be recorded/stored in a “non-transitory computer readable medium”. In some embodiments, the non-transitory computer readable medium includes, for example, a semiconductor memory and/or a storage device. The semiconductor memory includes a memory card, a read only memory (ROM), a flash memory, a programmable logic circuit, or other semiconductor memories. The storage device includes a tape, a disk, a hard disk drive (HDD), a solid-state drive (SSD), or other storage devices. An electronic equipment (for example, a central processing unit (CPU), a controller, a microcontroller, or a microprocessor) may read and execute the programming codes from the non-transitory computer readable medium, thereby implementing the related functions of the remapping circuits RM51, RM71, RM91, and/or RM92.

In summary, the computing device and the data access method therefor described in the above embodiments may be applicable to the situation where the source addresses and/or the destination addresses are inconsecutive. In the case where multiple access addresses of the source memory RAM91 are multiple discrete addresses, the source address in the burst access instruction is the virtual address V0. The source memory circuit 910 may remap the virtual address V0 to the discrete addresses of the source memory RAM91, so as to correctly extract the pieces of data to the bus BUS31. For the bus BUS31, the source address (virtual address V0) in the burst access instruction is a representative address among multiple consecutive source addresses. In the case where multiple access addresses of the destination memory RAM92 are multiple discrete addresses, the destination address in the burst access instruction is another virtual address V′0. The destination memory circuit 920 may remap the virtual address V′0 to multiple discrete addresses of the destination memory RAM92, so as to store the pieces of data from the bus BUS31 to the correct addresses of the destination memory RAM92. For the bus BUS31, the destination address (virtual address V′0) in the burst access instruction is a representative address among multiple consecutive destination addresses. Therefore, regardless of whether the source addresses are inconsecutive and/or the destination addresses are inconsecutive, the bus BUS31 may operate in the burst mode to reduce bus traffic and improve bus efficiency.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A computing device, comprising:
a bus;
a destination memory circuit, coupled to the bus; and
a source memory circuit, coupled to the bus and used to provide a plurality of pieces of data to the destination memory circuit through the bus based on a burst access instruction,
wherein a source address in the burst access instruction is a representative address among a plurality of consecutive addresses corresponding to the pieces of data in the source memory circuit, a destination address in the burst access instruction is a virtual address, the destination memory circuit remaps the virtual address to a plurality of discrete addresses, and the destination memory circuit stores the pieces of data from the bus to the discrete addresses in the destination memory circuit; or
wherein a source address in the burst access instruction is a virtual address, the source memory circuit remaps the virtual address to a plurality of discrete addresses, the source memory circuit extracts the pieces of data from the discrete addresses in the source memory circuit to the bus, a destination address in the burst access instruction is a representative address among a plurality of consecutive addresses in the destination memory circuit, and the destination memory circuit stores the pieces of data from the bus to the consecutive addresses in the destination memory circuit; or
wherein a source address in the burst access instruction is a first virtual address, the source memory circuit remaps the first virtual address to a plurality of first discrete addresses, the source memory circuit extracts the pieces of data from the first discrete addresses in the source memory circuit to the bus, a destination address in the burst access instruction is a second virtual address, the destination memory circuit remaps the second virtual address to a plurality of second discrete addresses, and the destination memory circuit stores the pieces of data from the bus to the second discrete addresses in the destination memory circuit.

2. The computing device according to claim 1, wherein one of the destination memory circuit and the source memory circuit is a main memory, and other one of the destination memory circuit and the source memory circuit is an internal memory in a computing circuit.

3. The computing device according to claim 1, further comprising:
a direct memory access controller, coupled to the bus and used to issue the burst access instruction, control the source memory circuit to provide the pieces of data, and control the destination memory circuit to store the pieces of data.

4. The computing device according to claim 1, wherein the destination memory circuit comprises:
a destination memory; and
a remapping circuit, coupled to the bus and the destination memory, wherein the remapping circuit remaps the virtual address or the second virtual address to the discrete addresses or the second discrete addresses of the destination memory, and the destination memory stores the pieces of data from the bus to the discrete addresses or the second discrete addresses of the destination memory.

5. The computing device according to claim 1, wherein the source memory circuit comprises:
a source memory; and
a remapping circuit, coupled to the bus and the source memory, wherein the remapping circuit remaps the virtual address or the first virtual address to the discrete addresses or the first discrete addresses of the source memory, and the source memory extracts the pieces of data from the discrete addresses or the first discrete addresses of the source memory to the bus.

6. A data access method of a computing device, comprising:
providing a plurality of pieces of data to a destination memory circuit of the computing device through a bus of the computing device based on a burst access instruction by a source memory circuit of the computing device, wherein a source address in the burst access instruction is a representative address among a plurality of consecutive addresses corresponding to the pieces of data in the source memory circuit, and a destination address in the burst access instruction is a virtual address;
remapping the virtual address to a plurality of discrete addresses by the destination memory circuit; and
storing the pieces of data from the bus to the discrete addresses in the destination memory circuit by the destination memory circuit.

7. The data access method according to claim 6, wherein one of the destination memory circuit and the source memory circuit is a main memory, and other one of the destination memory circuit and the source memory circuit is an internal memory in a computing circuit.

8. The data access method according to claim 6, further comprising:
remapping the virtual address to the discrete addresses of a destination memory of the destination memory circuit by a remapping circuit of the destination memory circuit; and
storing the pieces of data from the bus to the discrete addresses of the destination memory by the destination memory.

9. A data access method of a computing device, comprising:
remapping a virtual address to a plurality of discrete addresses by a source memory circuit of the computing device;
extracting a plurality of pieces of data from the discrete addresses in the source memory circuit by the source memory circuit;
providing the pieces of data to a destination memory circuit of the computing device through a bus of the computing device based on a burst access instruction by the source memory circuit, wherein a source address in the burst access instruction is the virtual address, and a destination address in the burst access instruction is a representative address among a plurality of consecutive addresses in the destination memory circuit; and
storing the pieces of data from the bus to the consecutive addresses in the destination memory circuit by the destination memory circuit.

10. The data access method according to claim 9, wherein one of the destination memory circuit and the source memory circuit is a main memory, and other one of the destination memory circuit and the source memory circuit is an internal memory in a computing circuit.

11. The data access method according to claim 9, further comprising:
remapping the virtual address to the discrete addresses of a source memory of the source memory circuit by a remapping circuit of the source memory circuit; and
extracting the pieces of data from the discrete addresses of the source memory to the bus by the source memory.

12. A data access method of a computing device, comprising:
remapping a first virtual address to a plurality of first discrete addresses by a source memory circuit of the computing device;
extracting a plurality of pieces of data from the first discrete addresses in the source memory circuit by the source memory circuit;
providing the pieces of data to a destination memory circuit of the computing device through a bus of the computing device based on a burst access instruction by the source memory circuit, wherein a source address in the burst access instruction is the first virtual address, and a destination address in the burst access instruction is a second virtual address;
remapping the second virtual address to a plurality of second discrete addresses by the destination memory circuit; and
storing the pieces of data from the bus to the second discrete addresses in the destination memory circuit by the destination memory circuit.

13. The data access method according to claim 12, wherein one of the destination memory circuit and the source memory circuit is a main memory, and other one of the destination memory circuit and the source memory circuit is an internal memory in a computing circuit.

14. The data access method according to claim 12, further comprising:
remapping the second virtual address to the second discrete addresses of a destination memory of the destination memory circuit by a remapping circuit of the destination memory circuit; and
storing the pieces of data from the bus to the second discrete addresses of the destination memory by the destination memory.

15. The data access method according to claim 12, further comprising:
remapping the first virtual address to the first discrete addresses of a source memory of the source memory circuit by a remapping circuit of the source memory circuit; and
extracting the pieces of data from the first discrete addresses of the source memory to the bus by the source memory.
